(19) United States
(12) Patent Application Publication
(10) Pub. No.: US 2006/0139959 A1
(43) Pub. Date: Jun. 29, 2006

(54) Backlight assembly and liquid crystal display device having the same

(76) Inventors: Hyun-Chul Bae, Suwon-si (KR); Hyeon-Yong Jang, Osan-si (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/285,902

(22) Filed: Nov. 23, 2005

(30) Foreign Application Priority Data
Nov. 25, 2004 (KR) 10-2004-97633

(51) Int. Cl. F21V 7/04

(52) U.S. Cl. 362/615

(57) ABSTRACT

In a backlight assembly that provides improved luminance uniformity and a LCD device having the same, the backlight assembly includes a flat fluorescent lamp and a receiving container. The receiving container has a bottom plate and sidewalls to receive the surface light source. The bottom plate includes openings that overlap the outermost lateral discharge spaces located along the edges of the flat fluorescent lamp. The openings are formed at corner portions of the bottom plate and extend parallel to the discharge spaces of the lamp. The backlight assembly further includes a buffer member interposed between the flat fluorescent lamp and the receiving container to support the flat fluorescent lamp. The buffer member includes protrusions couplable to holes of the receiving container, allowing the buffer member to be firmly secured to the receiving container. The device decreases current leakage of the surface light source, thus improving luminance uniformity.

### CROSS-REFERENCE TO RELATED APPLICATION

This application relies for priority on Korean Patent Application No. 2004-97633 filed on Nov. 25, 2004, the content of which is herein incorporated by reference in its entirety.

### BACKGROUND OF THE INVENTION

1. Field of the Invention

The present invention relates generally to a backlight assembly and a liquid crystal display (LCD) device having the backlight assembly. More particularly, the present invention relates to a backlight assembly capable of improving the luminance uniformity of light and an LCD device having the same.

2. Description of the Related Art

An LCD device, in general, displays images by using liquid crystal molecules. LCD device is a type of flat panel display devices that is becoming increasingly popular. One of the reasons for this increasing popularity of LCD devices is that it has various desirable characteristics such as thinness, light weight, low driving voltage requirement, low power consumption, etc. Today, LCD devices are widely used in various industrial fields.

The LCD device is a non-emissive type display device, and therefore it is often used with a light source such as a backlight assembly. A hollow, cylindrical-shaped cold cathode fluorescent lamp (CCFL) has been widely used as a conventional backlight assembly. Although CCFL functioned well as the backlight assembly light source thus far, the recent trend of increasing LCD device sizes created shortcomings with the CCFL. For example, since larger devices require more CCFLs per device, manufacturing cost increased beyond the desirable level and optical properties such as a uniformity of luminance are deteriorated.

To solve the above-mentioned problems, research has been focused on a flat fluorescent lamp, which generates light not as a line but a surface. A surface light source includes a lamp body having a plurality of discharge spaces and electrodes that apply discharge voltages to the lamp body. The surface light source generates a plasma discharge in each of the discharge spaces by the discharge voltages that are applied from an exterior inverter to the electrodes. Due to the plasma discharge in the discharge space, an ultraviolet light is generated. A fluorescent layer in the lamp body is excited by the ultraviolet light, thereby generating a visible light.

However, the surface light source has a problem in that the luminance uniformity of light is remarkably reduced near the end portions of each discharge space compared to the central portions thereof. Research on the problem reveals that the reduction of the luminance uniformity results from a current leakage generated between the surface light source and the receiving container that includes a metal. This current leakage reduces the luminance uniformity of light in an LCD device, thereby deteriorating the display quality of the LCD device.

A method of reducing the current leakage between the surface light source and the receiving container would improve the quality of LCD devices made with surface light sources.

### SUMMARY OF THE INVENTION

The present invention provides a backlight assembly capable of improving the uniformity of luminance of light that is generated from a surface light source.

The present invention provides an LCD device having the above mentioned backlight assembly.

In one aspect of the invention, a backlight assembly includes a surface light source and a receiving container. The surface light source includes a plurality of discharge spaces that are spaced apart from and aligned parallel to each other. The discharge spaces include an outermost lateral discharge space that is positioned near an edge of the surface light source. The receiving container includes a bottom plate and sidewalls to receive the surface light source. The bottom plate includes a plurality of openings that are positioned to overlap the outermost lateral discharge spaces when the surface light source is combined with the receiving container. The openings may extend in the same direction as the discharge spaces, and may be formed at corner portions of the bottom plate. The surface light source includes a lamp body and electrodes that are formed at end portions of the lamp body. The electrodes are extended substantially perpendicular to a direction in which the discharge spaces extend, thereby partially covering the discharge spaces. A portion of the opening partially overlaps the electrode, and the opening extends beyond the electrode in the direction in which the discharge space extend. Where there are a plurality of outermost lateral discharge spaces located along different edges of the surface light source, each of the openings partially overlaps an end portion of one of the utmost lateral discharge spaces and extends in parallel with the discharge space to a predetermined opening length measured from the end portion of the utmost lateral discharge space.

In another aspect of the invention, the backlight assembly includes a surface light source, a receiving container and a buffer member. The surface light source includes a plurality of discharge spaces to generate light. The receiving container includes a bottom plate and sidewalls to receive the surface light source. The bottom plate includes first coupling portions that are formed along a peripheral portion of the bottom plate. The buffer member is interposed between the surface light source and the receiving container, and includes second coupling portions that are coupled to the first coupling portions. The buffer member supports the edges of the surface light source.

In still another aspect of the invention, an LCD device includes a backlight assembly and an LCD panel. The backlight assembly includes a surface light source and a receiving container. The surface light source includes a plurality of discharge spaces to generate light. The discharge spaces are spaced apart from and aligned parallel to each other. The receiving container includes a bottom plate and sidewalls to receive the surface light source. The bottom plate includes a plurality of openings corresponding to outermost lateral discharge spaces that are adjacent to surroundings of the surface light source. The openings are formed along a longitudinal direction of the discharge space, and are formed at corner portions of the bottom plate. The backlight assembly further includes a buffer member that is interposed between the surface light source and the receiving container to support the surface light source. The buffer member supports a edges of the surface light source.

According to the backlight assembly and the LCD device having the same, current leakage of the discharge spaces is decreased so that the uniformity of luminance of the light that is generated from the surface light source is improved. In addition, the buffer member has protrusions so that the buffer member may be firmly fixed to the receiving container.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing a backlight assembly in accordance with an exemplary embodiment of the present invention;

FIG. 2 is an enlarged view showing a corner portion of the receiving container shown in FIG. 1;

FIG. 3 is a perspective view showing a rear surface of the buffer member shown in FIG. 1;

FIG. 4 is a cross-sectional view taken along a first direction shown in FIG. 1;

FIG. 5 is a cross-sectional view taken along a second direction shown in FIG. 1;

FIG. 6 is a cross-sectional view showing a modified embodiment of the backlight assembly shown in FIG. 5;

FIG. 7 is a perspective view showing the flat fluorescent lamp shown in FIG. 1;

FIG. 8 is a cross-sectional view taken along a line I-I′ shown in FIG. 7;

FIG. 9 is an exploded perspective view showing a liquid crystal display device in accordance with an exemplary embodiment of the present invention; and

FIG. 10 is a cross-sectional view showing the LCD device shown in FIG. 9.

### DESCRIPTION OF THE EMBODIMENTS

It should be understood that the exemplary embodiments of the present invention described below may be varied and modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Hereinafter, the present invention will be described in detail with reference to the accompanying drawings.

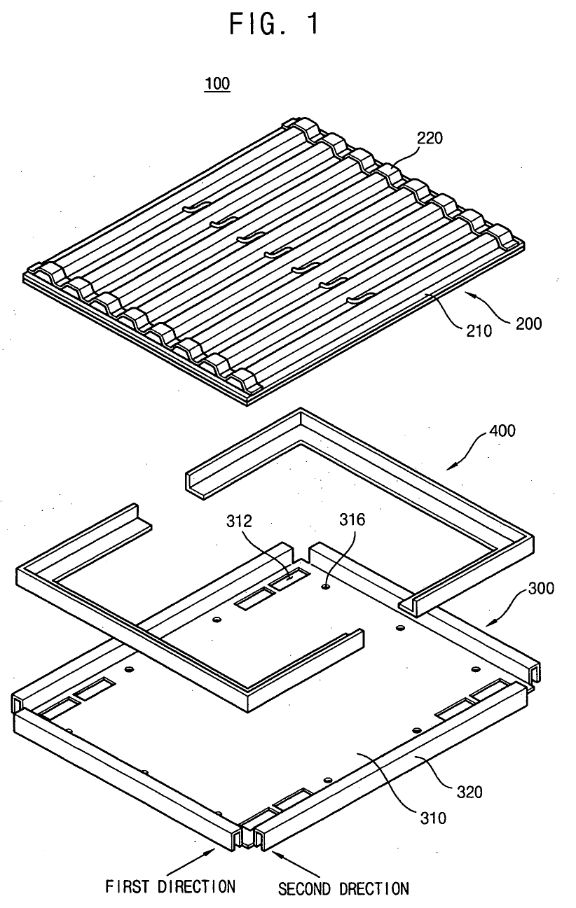

FIG. 1 is an exploded perspective view showing a backlight assembly in accordance with an exemplary embodiment of the present invention.

Referring to FIG. 1, a backlight assembly 100 in accordance with an exemplary embodiment includes a flat fluorescent lamp 200 and a receiving container 300.

The flat fluorescent lamp 200 includes a lamp body 210 that generates light and a plurality of electrodes 220 that are formed at end portions of the lamp body 210. The lamp body 210 has a rectangular shape in a plan view and generates surface light. When a discharge voltage is applied from an exterior inverter (not shown) to the electrodes 220 of the flat fluorescent lamp 200, a plasma discharge is generated in an inner space of the flat fluorescent lamp 200. An ultraviolet light radiates from the inner space of the flat fluorescent lamp 200 and excites electrons of a fluorescent layer deposited on an internal surface of the fluorescent lamp. As a result, visible light is generated from the flat fluorescent lamp 200. The flat fluorescent lamp 200 has a large radiation surface, and the inner space of the flat fluorescent lamp is divided into a plurality of discharge spaces to increase radiation efficiency. The electrodes 220 extend in a direction that is substantially perpendicular to the discharge spaces, and the electrodes 220 extend across all of the discharge spaces at both end portions of the discharge spaces.

The receiving container 300 includes a bottom plate 310 and sidewalls 320, each of which protrudes upward from an area near the edges of the bottom plate 310. The sidewalls 320 and the bottom plate 310 define a receiving space Into which the flat fluorescent lamp 200 is placed. In the present embodiment, each of the sidewalls 320 has a U-shaped cross-section, as shown in FIG. 1. This U-shaped cross section confers added mechanical strength to the sidewalls 320 and provides an assembly area for facilitating an assembly of the receiving container 300 with other elements such as a first mold (not shown), a second mold (not shown) and the like. Preferably, the receiving container 300 is made of a metal for its high strength and high deformation resistance.

A plurality of openings 312 are formed near the edges of the bottom plate 310 and are located to overlap with the outermost discharge spaces. In the present embodiment, the openings 312 are formed near every corner portion of the bottom plate 310 and extend in the same direction as the discharge spaces, so that the end portions of the outermost lateral discharge spaces are aligned with the openings 312. The outermost lateral discharge spaces are formed near the edges of the lamp body 210 along a longitudinal direction thereof, and are adjacent to components surroundings the flat fluorescent lamp 200. A parasitic capacitance is generated between the flat fluorescent lamp 200 and the receiving container 300, and a current leakage is generated between the flat fluorescent lamp 200 and the receiving container 300 due to the parasitic capacitance. The openings 312 decrease the parasitic capacitance between the flat fluorescent lamp 200 and the receiving container 300, so that the current leakage from the surface light source may be decreased.

The backlight assembly 100 further includes a buffer member 400 interposed between the flat fluorescent lamp 200 and the receiving container 300. The buffer member 400 supports the flat fluorescent lamp 200. In an exemplary embodiment, the buffer member 400 is made of an insulation material and is positioned between the periphery of the flat fluorescent lamp 200 and the receiving container 300. This way, the flat fluorescent lamp 200 is spaced apart from the receiving container 300 and makes no electrical contact with the receiving container 300, thus avoiding the current leakage problem. The buffer member 400 may include an elastic material, such as silicone, in order to absorb external shocks.

In the present embodiment, the buffer member 400 includes two pieces of a U-shaped open frame. However, this is not a limitation of the invention and four pieces of an L-shaped corner frame, a single piece of closed frame or any other configuration known to one of ordinary in the art may also be utilized as the buffer member 400 in place of the two pieces of U-shaped open frame. Four pieces of the L-shaped corner frame may support each side or corner of the flat fluorescent lamp 200, and the closed frame may support all the edges of the flat fluorescent lamp 200.

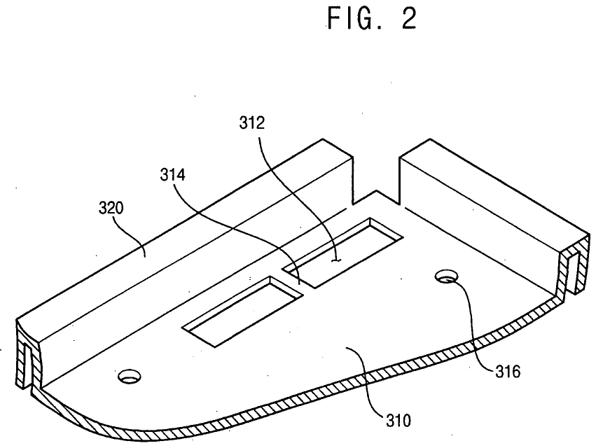

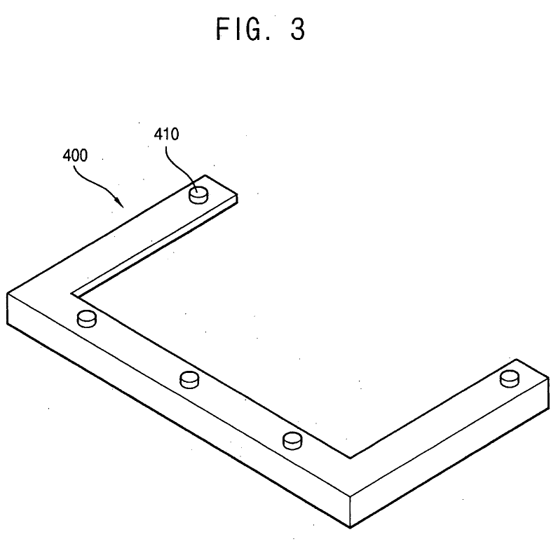

FIG. 2 is an enlarged view showing a corner portion of the receiving container shown in FIG. 1. FIG. 3 is a perspective view showing a rear surface of the buffer member shown in FIG. 1.

Referring to FIGS. 1 to 3, the openings 312 are formed around every corner portion of the bottom plate 310 and extend along the discharge space, so that both end portions of the outermost lateral discharge spaces correspond to the openings 312. In the present embodiment, each of the openings 312 extends along the discharge space and is formed into a rectangular shape. As a size of the opening 312 is increased, the receiving container 300 could be deformed due to lack of structural enforcement. Thus, a bridge member 314 is formed across a central portion of the rectangular opening 312. In the present embodiment, one or more of the bridge member 314 is formed in order to maintain the mechanical strength of the receiving container 300.

A plurality of first coupling portions 316 is formed at the bottom plate 310 of the receiving container 300. The buffer member 400 is coupled to the receiving container 300 through the first coupling portions 316. In the present embodiment, the first coupling portions 316 include a series of circular-shaped holes penetrating the are near the edges of the bottom plate 310. Although not shown in the figures, the holes 316 may be of any shape (e.g., a rectangular shape) that would be known to one of ordinary skill in the art.

The buffer member 400 is disposed along the periphery of the bottom plate 310 to support the edges of the flat fluorescent lamp 200 corresponding to the openings 312 and the first coupling portions 316. The buffer member 400 includes a plurality of second coupling portions 410 corresponding to the first coupling portions 316. The second coupling portions 410 are disposed on a rear surface of the buffer member 400 that faces the bottom plate 310, and are coupled to the first coupling portions 316. In the present embodiment, the second coupling portion 410 is formed as a protruding member designed to fit with the holes 316, so that the protruding member is inserted into the holes 316, thereby firmly securing the buffer member 400 to the receiving container 300. Although not shown in figures, the buffer member 400 may further include a protruding member that is inserted into the openings 312, as would be known to one of the ordinary skill in the art. While one first coupling portion is joined with one second coupling portion in the particular embodiment, this is not a limitation of the invention.

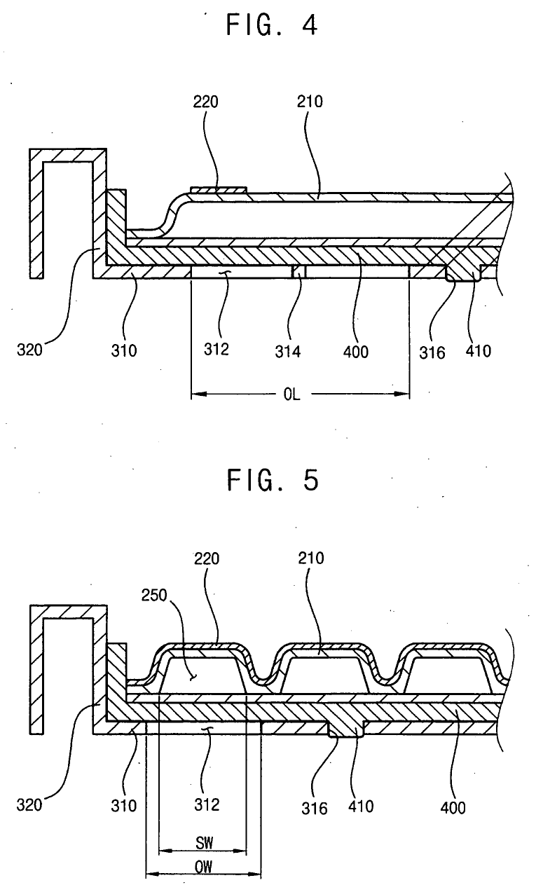

FIG. 4 is a cross-sectional view taken along a first direction shown in FIG. 1. FIG. 5 is a cross-sectional view taken along a second direction shown in FIG. 1.

Referring to FIGS. 4 and 5, the openings 312 are formed near the edges of the bottom plate 310 along the discharge space, so that both end portions of the outermost lateral discharge spaces are aligned with the openings 312. The rectangular opening 312 partially overlaps with the electrode 220 and extends beyond the are that is covered by the electrode 220, along the first direction. An opening length OL of the opening 312 is determined in accordance with the electrical properties of the flat fluorescent lamp 200 and the mechanical properties of the receiving container 300. The opening 312 has the opening length OL, which is selected so that it does not reduce the strength of the receiving container 300 under the condition that the parasitic capacitance between the flat fluorescent lamp 200 and the receiving container 300 is minimized. In the present embodiment, the opening length OL of the opening 312 is adjusted to be no more than about 20 cm based on the above reasons. An opening width OW of the opening 312 may be greater than or equal to a space width SW of the discharge space 250, thereby minimizing the current leakage of the flat fluorescent lamp 200.

The buffer member 400 is secured to the receiving container 300 by insertion of the protruding member 410 into the hole 316, and the protruding member 410 has the same size as the hole 316. Accordingly, the insertion of the protruding member 410 into the hole 316 necessarily requires applying some external force, so that the protruding member 410 and the hole 316 are under an interference fit or a transition fit. As a result, the buffer member 400 is firmly secured to the receiving member 300 by a frictional force in the state of the interference fit or the transition fit, and the commonly-performed additional process for securing the buffer member 400 to the receiving container 300 by using a double-sided adhesive tape is omitted.

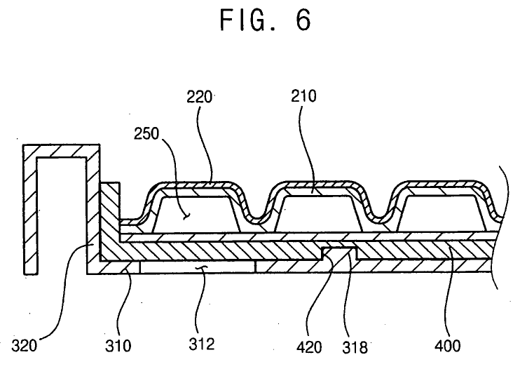

FIG. 6 is a cross-sectional view showing a modified embodiment of the backlight assembly shown in FIG. 5. The modified embodiment of the backlight assembly shown in FIG. 6 has the same structure as described with reference to FIG. 5, except for a first coupling portion and a second coupling portion. The reference numerals in FIG. 6 denote the same or like parts or elements in FIG. 5 and any further detailed descriptions of the same elements or parts will be omitted.

Referring to FIG. 6, a first coupling portion 318 is formed on the bottom plate 310 of the receiving container 300, and a second coupling portion 420 is formed on the buffer member 400. The first coupling portion 318 is coupled to the second coupling portion 420, so that the buffer member 400 is secured to the receiving container 300. In the present embodiment, the first coupling portion 318 is a protrusion protruding from the bottom plate 310 toward the buffer member 400. The second coupling portion 420 is a hole in which the protrusion 318 may be inserted.

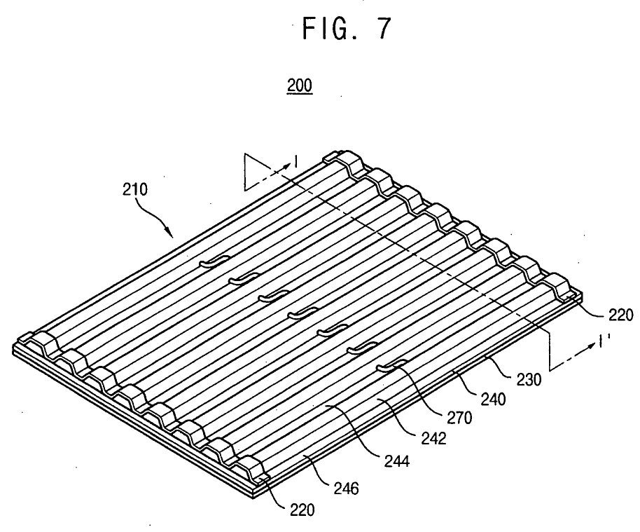

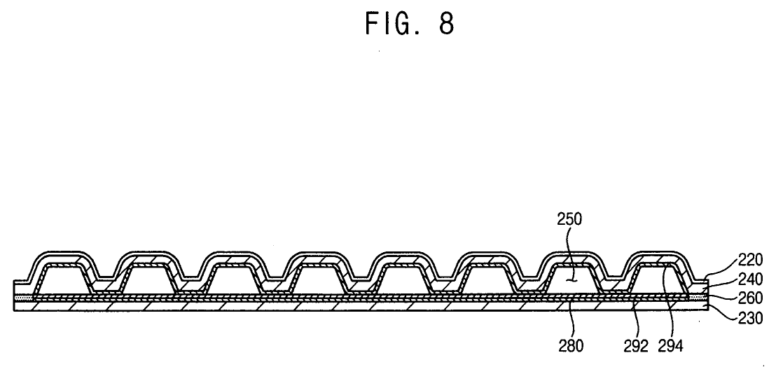

FIG. 7 is a perspective view showing the flat fluorescent lamp shown in FIG. 1. FIG. 8 is a cross-sectional view taken along a line I-I′ shown in FIG. 7.

Referring to FIGS. 7 and 8, a flat fluorescent lamp 200 includes a lamp body 210 that generates light and electrodes 220 that are formed at both end portions of the lamp body 210, respectively.

The lamp body 210 includes a first substrate 230 and a second substrate 240 that is combined with the first substrate 230 to form a plurality of discharge spaces 250.

As an exemplary embodiment, the first substrate 230 has a rectangular plate shape and is comprised of glass. The first substrate 230 may include a black matrix in order to prevent leakage of an ultraviolet light in the discharge spaces 250. The second substrate 240 includes a plurality of discharge space portions 242, a plurality of space division portions 244 and a sealing portion 246. The discharge space portions 242 are spaced apart from the first substrate 230 to form the discharge spaces 250. Each of the space division portions 244 is formed between the neighboring discharge space portions 242 and makes contact with the first substrate 230. The sealing portion 246 is formed near the edges of the discharge space portions 242 and the space division portions 244 to be combined with the first substrate 230. The second substrate 240 comprises, for example, a transparent material that transmits an ultraviolet light generated from the discharge spaces 250. For example, the second substrate 240 may include glass. The second substrate 240 may also include a black matrix to prevent leakage of the ultraviolet light.

In the present embodiment, the second substrate 240 having the above-described structure is formed through a molding process. A base substrate such as a plate (like the first substrate 230) is heated to a predetermined temperature, and a shape of a predetermined mold is inscribed on a surface of the heated base substrate to form the discharge space portions 242, the space division portions 244 and the sealing portion 246. While the above exemplary embodiment describes the second substrate created by performing the molding process on a heated base substrate, the second substrate could also be created by an air blowing onto a surface of the heated base substrate in accordance with a desirable shape or any other modified technique known to one of the ordinary skill in the art.

As shown in FIG. 7, each cross-sectional surface of the discharge space portions 242 has an arch shape, so that a cross-sectional surface of the second substrate 240 has a series of arches. However, the cross sectional surface of the second substrate 240 may be represented as various shapes such as a semicircular shape and a rectangular shape, as would be known to one of the ordinary skill in the art.

A plurality of connection passages 270 are formed on the second substrate 240 to connect the discharge spaces 250 adjacent to each other. At least one of the connection passages 160 is formed on each of the space division portions 244. Air in the discharge space 250 is exhausted through the connection passage 270, and the discharge gas for generating a plasma discharge is supplied to the discharge space 250 through the connection passages 270. In the present embodiment, the connection passage 270 is formed in the molding process for the second substrate 120 simultaneously when the second substrate 240 is molded. The connection passage 270 may have various shapes if only the discharge spaces 250 are sufficiently connected to each other through the connection passage 270. For example, the connection passage 270 is formed into an S-shape.

The second substrate 240 is combined with the first substrate 230 through an adhesive member 260. The adhesive member 260 may be, for example, a frit. A frit is a mixture of glass and metal, and has a melting point lower than the glass of the first and second substrates 230 and 240. The frit is interposed between the first and second substrates 230 and 240 along the sealing portion 246, so that the first substrate 230 and the second substrate 240 are combined with each other. In such a case, the frit is positioned along the sealing portion 246 but not the space division portion 244.

The space division portion 244 of the second substrate 240 adheres closely to the first substrate 230 by a pressure difference between an internal pressure and an external pressure of the discharge space 250. When air in the discharge space 250 is discharged through the connection passage 270 after combining the first and second substrates 230 and 240, the inside of the discharge space 250 is almost a vacuum. Thereafter, various discharge gases for accelerating a plasma discharge are provided into the discharge spaces 250 through the connection passage 270. Examples of the discharge gas include a mercury gas, a neon gas, an argon gas, a krypton gas, etc. These can be used alone or in combinations. After providing the discharge gas into the discharge spaces 250, electric power is applied to the electrode 220 and the plasma discharge is generated in the discharge space 250. In such a case, while an internal pressure of the discharge space 250 is about 50 Torr to about 70 Torr, an external pressure of the discharge space 250 is about 760 Torr (i.e., at atmospheric pressure). Accordingly, a pressure difference between the internal and external pressures of the discharge space 250 generates a sufficient compressive force applied to the second substrate 240. As a result, the space division portions 244 of the second substrate 240 make close contact with the first substrate 230 due to the pressure difference.

As shown in FIG. 8, the lamp body 210 includes a reflective layer 280, a first fluorescent layer 292 and a second fluorescent layer 294. The reflective layer 280 is formed between an upper surface of the first substrate 230 and a lower surface of the second substrate 240 such that the reflective portion is closer to the second substrate 240 than to the first substrate 230. The first fluorescent layer 292 is formed on the reflective layer 280. The second fluorescent layer 294 is formed on the lower surface of the second substrate 240. The reflective layer 280 reflects the visible light generated from the first and second fluorescent layers 292 and 294 toward the second substrate 240 to prevent a leakage of the visible light through the first substrate 230. The reflective layer 280 includes a metal oxide in order to increase its reflectivity and suppress variation of a color coordinate. Examples of materials suitable for the reflective layer 280 include an aluminum oxide (Al₂O₃) layer, a barium sulfate (BaSO₄) layer, etc. These materials can be used alone or in combinations.

Electrons of the first and second fluorescent layers 292 and 294 are excited by the ultraviolet light that is generated by a plasma discharge in the discharge spaces 250, and thus visible light is generated from the first and second fluorescent layers 292 and 294. The reflective layer 280 and the first and second fluorescent layers 292 and 294 are formed in the shape of a thin film by a spraying process before combining the first substrate 230 with the second substrate 240. In such a case, the reflective layer 280 and the first fluorescent layer 292 are coated on the whole upper surface of the first substrate 230 except for the areas near the edges corresponding to the sealing portion 246 of the second substrate 240. The second fluorescent layer 294 is formed on the whole lower surface of the second substrate 240 except for the sealing portion 246. Alternatively, the reflective layer 280 and the first fluorescent layer 292 may be formed on the whole upper surface of the first substrate 230 except for the portions corresponding to the space division portions 244 and the sealing portion 246 of the second substrate 240. The second fluorescent layer 294 may be formed on the whole lower surface of the second substrate 240 except for the space division portions 244 and the sealing portion 246 of the second substrate 240.

The electrodes 220 are formed on an area near the periphery of the upper surface of the second substrate 240 and extend in a direction that is perpendicular to the direction in which the discharge spaces 250 extend, so that the electrodes 220 extend across all of the discharge spaces 250. Accordingly, both end portions of each discharge portion 250 are covered with the electrodes 220. The electrodes 220 are comprised of a conductive material to apply a discharge voltage that is amplified through an exterior inverter to the lamp body 210. For example, the electrodes 220 may be formed by coating a silver paste on the upper surface of the second substrate 240. The silver paste is a mixture of silver (Ag) and silicon oxide (SiO2). In addition, the electrodes 220 are formed by spray coating a metallic powder. The metallic powder comprises copper, nickel, silver, gold, chromium, etc. These can be used alone or in combinations. Alternatively, the electrodes 220 may be formed on a lower surface of the first substrate 230. When the electrodes 220 are formed on the first and second substrates 230 and 240, respectively, the electrodes 220 that are formed on the lower surface of the first substrate 230 and the electrodes 220 that are formed on the upper surface of the second substrate 240 are connected to one another by a conductive clip. In addition, the electrodes 220 may be formed in the lamp body 210.

While the present embodiment discloses forming a plurality of discharge space portions by using molding process against the second substrate for dividing a plurality of the discharge spaces in the lamp body, the discharge spaces may be divided by a plurality of partitions between the first and second substrates that have substantially identical shapes, as would be known to one of the ordinary skill in the art. In such a case, both of the fist and second substrates may be shaped into a plate, for example.

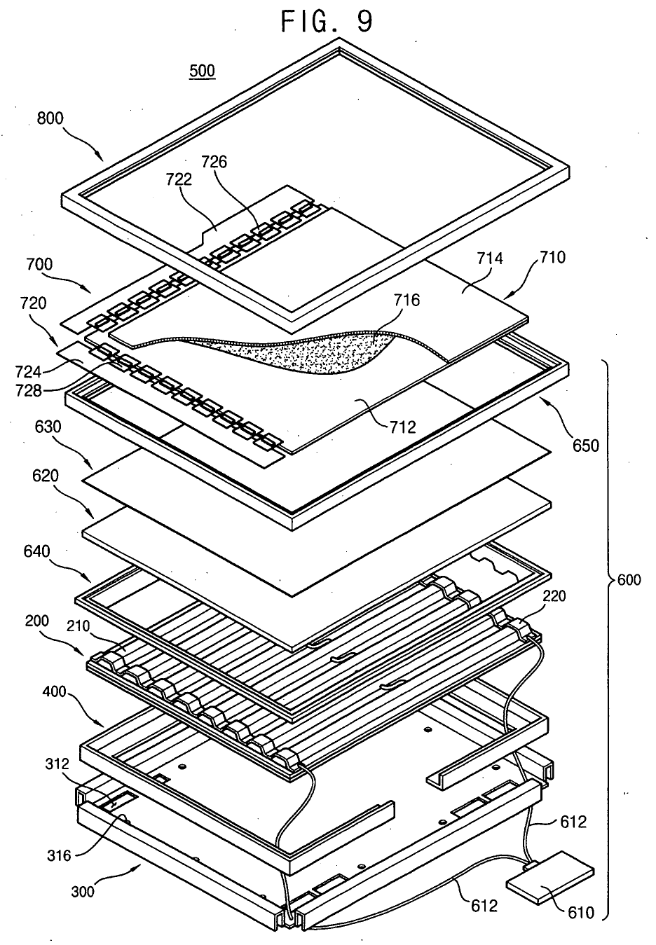

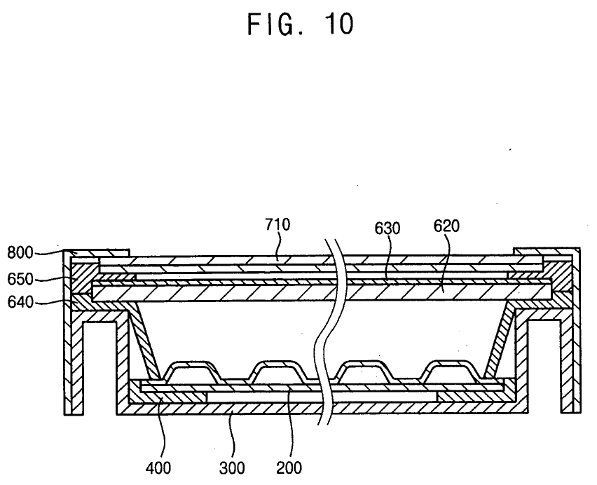

FIG. 9 is an exploded perspective view showing an LCD device in accordance with an exemplary embodiment of the present invention. FIG. 10 is a cross-sectional view showing the LCD device shown in FIG. 9.

Referring to FIGS. 9 and 10, the LCD device 500 according to the present embodiment includes a backlight assembly 600 and a display unit 700. The backlight assembly 600 supplies a light to the display unit 700. The display unit 700 displays an image using the light supplied from the backlight assembly 600.

The backlight assembly 600 includes a flat fluorescent lamp 200, a receiving container 300 and a buffer member 400. The flat fluorescent lamp 200, the receiving container 300 and the buffer member 400 in the present embodiment have the same structures as what is described above in reference to FIG. 1. Thus, in FIGS. 9 and 10, the reference numerals denote the same or like parts as in FIG. 1, and any further descriptions of the same elements will be omitted.

The backlight assembly 600 further includes an inverter 610, a diffusion plate 620 and an optical sheet 630. The inverter 610 generates a discharge voltage to operate the flat fluorescent lamp 200. The diffusion plate 620 is disposed over the flat fluorescent lamp 200 and diffuses light that is generated from the flat fluorescent lamp 200. The optical sheet 630 is on the diffusion plate 620.

The inverter 610 inverts a low frequency alternating voltage generated from an exterior power source into a high frequency alternating voltage sufficient for operating the flat fluorescent lamp 200, thereby generating the discharge voltage for generating a discharge plasma in the discharge spaces. In the present embodiment, the inverter 610 is disposed on a rear surface of the receiving container 300. The discharge voltage is applied to the electrodes 220 of the flat fluorescent lamp 200 through first and second power supply lines 612 and 614.

The diffusion plate 620 diffuses the light generated from the flat fluorescent lamp 200, thereby improving the luminance uniformity of the light. The diffusion plate 620 is a plate of a predetermined thickness, and is spaced apart from the flat fluorescent lamp 200. The diffusion plate 620, for example, may contain poly methyl methacrylate (PMMA) and include a diffusing agent for diffusing the light.

The optical sheet 630 changes the optical path of the diffused light passing through the diffusion plate 620, thereby improving the optical characteristics of the light. The optical sheet 630 may include a prism sheet. The prism sheet guides the diffused light toward the LCD panel 710 to enhance the luminance of the light when viewing from a front of the LCD panel 710. The optical sheet 630 may further include a diffusion sheet (not shown) on or under the prism sheet for re-diffusing the diffused light through the diffusion plate 620.

The backlight assembly 600 may further include a first mold 640 and a second mold 650. The first mold 640 secures the flat fluorescent lamp 200 to the receiving container 300 and supports the diffusion plate 620. The second mold 650 secures the diffusion plate 620 and the optical sheet 630 to the receiving container 300 and supports the LCD panel 710.

The first mold 640 makes contact with the peripheral portion of the flat fluorescent lamp 200 and is assembled to the sidewall 320 of the receiving container 300, so that the flat fluorescent lamp 200 is secured to the receiving container 300. Although the present embodiment exemplarily discloses a single-piece closed frame as the first mold 640, two pieces of U-shaped or L-shaped open frame or any other configuration known to one of the ordinary skill in the art may also be utilized as the first mold 640 in place of the closed frame.

The second mold 650 makes contact with the edges of a top surface of the optical sheet 630 and is assembled to the sidewall 320 of the receiving container 300, so that the optical sheet 630 and the diffusion plate 620 under the optical sheet 630 are secured to the receiving container 300. As is the case with the first mold 640, two pieces of U-shaped or L-shaped open frames or any other configuration known to one of the ordinary skill in the art may be utilized as the second mold 650 in place of the single-piece closed frame.

The display unit 700 includes an LCD panel 710 and a circuit part 720. The LCD panel 710 displays an image using light that is supplied from the backlight assembly 600. The circuit part 720 drives the LCD panel 710.

The LCD panel 710 includes a thin film transistor (TFT) substrate 712, a color filter substrate 714 facing the TFT substrate 712 and a liquid crystal 716 interposed between the TFT substrate 712 and the color filter substrate 714.

The TFT substrate 712 includes a transparent glass plate, where a plurality of TFTs (not shown) is arranged in a matrix shape as switching elements. A source electrode (not shown) of each TFT is electrically connected to a data line, and a gate electrode (not shown) of each TFT is electrically connected to a gate line. A drain electrode (not shown) of each TFT is electrically connected to a pixel electrode (not shown).

Color filters such as red, green and blue (RGB) unit pixels are coated on the color filter substrate 714 by a thin film process. A common electrode (not shown) comprising a transparent conductive material is formed on the color filter substrate 714.

When electric power is applied to the gate electrode of the TFT and the TFT is turned on, an electrical field is generated between the pixel electrode and the common electrode. Accordingly, the molecular arrangement of the liquid crystal molecules in the liquid crystal layer 716 is changed in response to the electric field, which in turn affects the transmittance of the light provided from the flat fluorescent lamp 610. By controlling the molecular arrangement of the liquid crystal molecules and by using a predetermined gray scale, desired images are displayed on the liquid crystal display panel 710.

The circuit part 720 includes a data printed circuit board (PCB) 720, a gate PCB 724, a data flexible circuit film 726 and a gate flexible circuit film 728. The data PCB 720 applies data driving signals to the LCD panel 710. The gate PCB 724 applies gate driving signals to the LCD panel 710. The data flexible circuit film 726 connects the data PCB 722 to the LCD panel 710. The gate flexible circuit film 728 connects the gate PCB 724 to the LCD panel 710. For example, each of the data and gate flexible circuit films 726 and 728 may be a tape carrier package (TCP) or a chip on film (COF).

In the present embodiment, the data flexible circuit film 726 is bent downwardly, and the data PCB 720 is positioned on a side or a rear surface of the receiving container 300. In the same way, the gate flexible circuit film 728 is also bent downwardly and the gate PCB 730 is positioned on a side or a rear surface of the receiving container 300. The gate PCB 730 may be omitted when signal wires (not shown) are formed on the LCD panel 710 and the gate flexible circuit film 728.

The LCD device 500 may further include a top chassis 800. The top chassis 800 surrounds the edges of the LCD panel 710, and is assembled with the receiving container 300 so that the LCD panel 710 is secured to the second mold 650. The top chassis 800 protects the LCD panel 710 from an external impact and prevents the LCD panel 710 from being separated from the second mold 650.

According to the backlight assembly and the LCD device having the backlight assembly, a plurality of openings is formed around corner portions of the bottom plate of the receiving container in parallel with the slender discharge space, so that the end portions of the two outermost lateral discharges overlap with the openings. Accordingly, current leakage from both end portions of the two outermost lateral discharges is suppressed and the luminance uniformity of a surface light that is generated from the flat fluorescent lamp is improved. In addition, the buffer member for supporting the flat fluorescent lamp includes a protruding member that is inserted into the holes of the bottom plate, so that the buffer member is stably secured to the receiving container.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A backlight assembly comprising:
a surface light source that includes a plurality of discharge spaces that are spaced apart from and aligned parallel to each other, the discharge spaces including an outermost lateral discharge space that is positioned near an edge of the surface light source; and
a receiving container that includes a bottom plate and side walls to receive the surface light source, the bottom plate having openings that are positioned to overlap the outermost lateral discharge space when the surface light source is combined with the receiving container.

2. The back light assembly of claim 1, wherein the openings extend in the same direction as the discharge spaces.

3. The backlight assembly of claim 1, wherein the openings are formed at corner portions of the bottom plate, respectively.

4. The backlight assembly of claim 1, wherein the surface light source comprises:
a lamp body; and
electrodes that are formed at end portions of the lamp body.

5. The backlight assembly of claim 4, wherein the electrodes extend substantially perpendicular to a direction in which the discharge spaces extend so that the electrodes partially cover all of the discharge spaces.

6. The backlight assembly of claim 5, wherein a portion of each of the openings partially overlaps the electrode and each of the openings extends beyond the electrode in the direction in which the discharge spaces extend.

7. The backlight assembly of claim 5, wherein there are a plurality of outermost lateral discharge spaces located along different edges of the surface light source, and wherein each of the openings partially overlaps an end portion of one of the outermost lateral discharge spaces, each of the openings extending parallel to the discharge space to a predetermined opening length measured from the end portion of the outermost lateral discharge space.

8. The backlight assembly of claim 7, wherein the opening length of the openings is no more than about 20 cm.

9. The backlight assembly of claim 4, wherein the lamp body comprises:
a first substrate; and
a second substrate including a plurality of discharge space portions, a plurality of space division portions and a sealing portion, the discharge space portions being spaced apart from the first substrate to form the discharge spaces, the space division portions making contact with the first substrate between neighboring discharge space portions, the sealing portion being formed along an edge of the surface light source.

10. The backlight assembly of claim 1, further comprising a buffer member that is interposed between the surface light source and the receiving container and supports the surface light source.

11. The backlight assembly of claim 10, wherein the buffer member supports edges of the surface light source.

12. A backlight assembly comprising:
a surface light source that includes a plurality of discharge spaces, the discharge spaces being spaced apart from and aligned parallel to each other;
a receiving container that includes a bottom plate and side walls to receive the surface light source, the bottom plate having a plurality of first coupling portions that are formed along edges of the bottom plate; and
a buffer member that is interposed between the surface light source and the receiving container to support the surface light source, the buffer member including a plurality of second coupling portions couplable to the first coupling portions.

13. The backlight assembly of claim 12, wherein each of the first coupling portions includes a hole and each of the second coupling portions includes a protrusion that is designed to fit the hole.

14. The backlight assembly of claim 12, wherein each of the first coupling portions includes a protrusion and each of the second coupling portions includes a hole.

15. The backlight assembly of claim 12, wherein the buffer member supports edges of the surface light source corresponding to the first coupling portions.

16. The backlight assembly of claim 12, wherein the bottom plate includes a plurality of openings that are positioned to overlap with outermost lateral discharge spaces that are located near edges of the surface light source.

17. The backlight assembly of claim 16, wherein the openings are formed at corner portions of the bottom plate and are substantially parallel to a direction in which the discharge spaces extend.

18. A liquid crystal display device comprising:
a backlight assembly including:
a surface light source that includes a plurality of discharge spaces, that are spaced apart from and aligned parallel to each other, the discharge including an outermost lateral discharge space that is positioned near an edge of the surface light source; and
a receiving container that includes a bottom plate and side walls to receive the surface light source, the bottom plate having openings that are positioned to overlap the outermost lateral discharge space when the surface light source is combined with the receiving container; and
a liquid crystal display panel that displays an image using light supplied from the backlight assembly.

19. The liquid crystal display device of claim 18, wherein the openings are formed at corner portions of the bottom plate and extend substantially parallel to the discharge spaces.

20. The liquid crystal display device of claim 18, wherein the surface light source comprises:
a lamp body; and
electrodes formed along opposite edges of the lamp body, the electrodes extending substantially perpendicular to the discharge space and partially covering the discharge spaces.

21. The liquid crystal display device of claim 20, wherein there are a plurality of outermost lateral discharge spaces located along different edges of the surface light source, and wherein each of the openings is partially covered by an end portion of one of the outermost lateral discharge spaces, each of the openings extending parallel to the discharge space to a predetermined opening length measured from the end portion of the outermost lateral discharge space.

22. The liquid crystal display device of claim 18, wherein the backlight assembly further includes a buffer member that is interposed between the surface light source and the receiving container and supports the surface light source.

23. The liquid crystal display device of claim 22, wherein the buffer member supports edges of the surface light source that align with the openings when the surface light source is assembled with the receiving container.

24. The liquid crystal display device of claim 23, wherein the receiving container includes a first coupling portion that is formed in the bottom plate to be coupled to the buffer member, and the buffer member includes a second coupling portion that is couplable to the first coupling portion.

25. The liquid crystal display device of claim 18, wherein the backlight assembly further includes:
an inverter that generates a discharge voltage to operate the surface light source;
a diffusion plate that is disposed over the surface light source, the diffusion plate diffusing light that is generated from the surface light source; and
an optical sheet that is disposed on the diffusion plate.

26. The liquid crystal display device of claim 25, wherein the backlight assembly further comprises:
a first mold that secures the surface light source to the receiving container and supports the diffusion plate; and
a second mold that secures the diffusion plate and the optical sheet to the receiving container and supports the liquid crystal display panel.
